(19) United States
(12) Patent Application Publication
(10) Pub. No.: US 2015/0313094 A1
(43) Pub. Date: Nov. 5, 2015

(54) MODULAR MICROENVIRONMENT TILE

(71) Applicant: Ivan Stojakovic, Kew Gardens, NY (US)

(72) Inventor: Ivan Stojakovic, Kew Gardens, NY (US)

(21) Appl. No.: 14/697,817

(22) Filed: Apr. 28, 2015

Related U.S. Application Data
(60) Provisional application No. 61/996,164, filed on Apr. 30, 2014.

(51) Int. Cl. A01G 9/02; A01G 27/00; A01G 7/04

(52) U.S. Cl. CPC A01G 9/02; A01G 7/045; A01G 27/00

(57) ABSTRACT

A modular microenvironment tile includes a base frame having a first section and a second section. The first section retains a vegetation module, and the second section retains an artwork module. The vegetation module includes vegetation in the form of live plants or dead but seemingly live plants, and the artwork module includes three-dimensional artwork non-including vegetation. The modular microenvironment tile can be advantageously used as a design or ornamental building block for environmental-friendly habitats or workspaces.

### CROSS-REFERENCE TO RELATED APPLICATIONS

The present application claims priority benefit of pending U.S. provisional patent application Ser. No. 61/996,164 filed Apr. 30, 2014, the entire disclosure of which is hereby incorporated by reference herein in its entirety.

### TECHNICAL FIELD

The disclosure of this application relates generally to prefabricated modular building materials, and in particular to a modular microenvironment tile (MMET) which can be used for decorative and eco-friendly building purposes in modern urban habitats.

### BACKGROUND

The idea and practice of incorporating natural elements into urban landscape and into urban interior habitats is well known and fairly abundant. Some examples include city parks, indoor gardens, aquariums, terrariums, flowerpots and more recently vertical wall gardens and green rooftops. Introducing a living or inanimate organic element into building design provides numerous benefits. Social and health benefits include creative ambiance, noise and heat reduction, and a sense of peace that comes only from the exposure of humans to nature. By exposing people to nature and, in particular, adding natural organic elements to architectural structures, the much-needed environmental awareness becomes more familiar to human beings. In turn, human beings become more aware of nature and learn to protect it.

Environmental conservation initiatives such as Leadership in Energy and Environmental Design (LEED) and Sustainable Sites Initiative (SITES®), as well as governmental agencies such as the Environmental Protection Agency (EPA), are promoting planning, design, construction and maintenance criteria for responsible and efficient use of eco-friendly building materials. A non-patent literature document by Richard L Hindle entitled “Inventing Landscapes” (Landscape Architecture Magazine Aug. 2013) summarizes some examples of technological advances geared to incorporating natural elements into architectural designs.

Recently, the so-called green walls and green roofs have become increasingly popular. A green wall or green roof is understood as having the surface of a wall or a roof partially or completely covered with vegetation. Vegetation may be planted directly or indirectly on the given surface. Planting vegetation indirectly is considered more popular and advantageous as many types of planters are readily available in commercial stores everywhere. One example of widely used vertical garden technology is based on “synthetic felt”. The synthetic felt is used to form pockets or slits directly on a wall surface to provide room for plant roots. The felt maintains the necessary moisture and enables for healthy plant rooting and growth. Various watering systems are being used, varying from spray bottle and natural rain to electrically powered irrigation systems (with or without fertilizer). An example is described in U.S. Pat. No. 8,141,294, and may be commercially available at Florafelt Vertical Garden Systems from Norcross Ga.

The technology related to planters has been developed for many years and is well established. For example, patent application publication US 2011/0258925 disclosed by Richard L. Baker (herein “Baker”) discloses vertical planters where one set of plants is oriented generally above another set of plants. In particular, Baker discloses a vertical planter having a watering system that allows the plants to be watered internally in the planter and drained downwardly into a water basin or reservoir. Baker's vertical planter is made of planter units that are vertically stackable to allow easy irrigation.

U.S. Pat. No. 7,757,436 to Bindschedler et al. (herein “Bindschedler”) discloses a modular greening device for populating facades or walls with vegetation. Specifically, Bindschedler's greening device includes a support structure which can be attached to the front of a facade or wall, and a plurality of modules containing plants; these modules are mounted on the support structure and can be individually removable to allow maintenance of the plants.

Patent application publication US 2008/0302009 disclosed by Frecon et al., (herein “Frecon”), discloses a support for any type of natural plants which can be used to decorate the wall of an apartment, an office or store. Frecon recognizes that ornamental decoration of walls is generally obtained by very thin flat objects, such as pictures, drawings, photographs, posters, etc., but no plants. Therefore, Frecon proposes a support which can be fastened to a wall and comprises one or more receptacles to accommodate mini or micro-plants. Therefore, it is evident that the state of the art in the field of adding vegetation (in particular plants) to a living habitat is well developed and well understood by persons having ordinary skill in the art.

The inventor herein recognizes that human beings living modern life styles have very little time and space to care for living organisms, such as plants or pets. However, at the same time, these people are desirous of “reconnecting” with nature. Prior art solutions, including the various types of planters or modular planting systems, as described above, would not only demand of time and attention from people's already busy schedules, but would also impose liabilities on their habitats.

For example, with the use of planters with irrigation systems, it is known that irrigation systems often fail and/or break down, and this would cause damage to delicate real estate property due to humidity or water leaks. Similarly, it is also known that plants can carry or develop microscopic organisms such as bacteria or fungi; these micro-organisms could in turn spread onto walls and floors therefore damaging the structure real estate property. For the above reasons, in many modern habitats, such as high-rise buildings, offices, hospitals and the like, vegetation such as live plants, moss, grass, ferns or the like are generally not recommended, and often are not even allowed. In places where vegetation is allowed, owners of real estate property often require assurances and/or insurance from tenants to allow the addition of vegetation to their habitats. As result, people living in modern habitats often prefer an artificial representation of nature such as a painting or photography (poster) of plants or flowers, or they even prefer large electronic screens (LCD screens) to display various representations of nature such as plants or animals.

In view of the above, there is a need for a simple solution that would allow people to add decorative vegetation to their living habitats, while at the same time minimizing their liability and requirement for care and maintenance for such vegetation. In addition, a need exists for a structure that allows for securely adding vegetation to living and working spaces while maintaining the design, ornament and beauty of such spaces.

### SUMMARY

In accordance with at least one embodiment, the present invention aims to uniquely contribute to the design, function, and the benefits of bringing elements of nature into urban settings without imposing a burden on human beings and yet providing a seamless way for a human to reconnect with nature.

According to the present invention, a Modular Microenvironment Tile (MMET) includes a frame of any shape, depth and volume, configured to be attached to or embedded into a surface. The surface may include a wall, a floor, a ceiling, an artwork, and/or even furniture. Within the frame, the MMET includes a first section having live vegetation or dead but seemingly live vegetation, and a second section having an artwork display. The vegetation may include live or dead but seemingly live plants, moss or grass; and the artwork display may include a painting or sculpture; preferably the artwork includes three-dimensional artwork.

Other modifications and/or advantages of present invention will become readily apparent to those skilled in the art from the following detailed description in reference to the drawings.

### BRIEF DESCRIPTION OF THE DRAWINGS

FIG. 1 illustrates an exemplary illustration of a Modular Microenvironment Tile (MMET);

FIG. 2A is a side view and FIG. 2B is a cross-sectional view of a vegetation module;

FIG. 3A is a perspective top view and FIG. 3B is a perspective bottom view of the vegetation module;

FIG. 4 illustrates a process of assembling a vegetation module and an artwork module into a base frame of the MMET;

FIG. 5 shows the vegetation module is removably contained within the base frame of the MMET;

FIG. 6A shows a vegetation module configured to be connected to an irrigation system for supplying irrigation liquid and/or nutrients to the plants contained within the vegetation module;

FIG. 6B shows a vegetation module configured to be connected to an irrigation system and covered with a clear casing to protect the plants contained within the vegetation module;

FIG. 7A and FIG. 7B show alternate options for supplying irrigation liquid or nutrients to the plants contained within the vegetation module;

FIG. 8A shows a partial view of an exemplary MMET including dead but seemingly live vegetation. FIG. 8B shows a complete three-dimensional view of a vegetation module forming a surface of a table;

FIG. 9A shows a perspective view of an exemplary MMET including dead but seemingly live vegetation. FIG. 9B shows a cross-sectional view of a vegetation module including dead but seemingly live vegetation;

FIG. 10 shows working example of an MMET having an artwork module and vegetation module with live plants, the MMET arranged on a floor surface, according to the present invention;

FIG. 11 shows an exemplary application of an MMET having a vegetation module with live plants arranged on a wall surface according to the present invention;

FIG. 12 shows an exemplary application of an MMET having a vegetation module with live plants arranged on a wall surface according to the present invention.

FIG. 13 shows an exemplary application in which a plurality of MMET units each having a vegetation module and an artwork module are arranged on a wall surface according to the present invention;

FIG. 14 illustrates a further application of an irregularly shaped MMET including a three-dimensional artwork module and a vegetation module in a large scale.

### DETAILED DESCRIPTION

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Before undertaking the DETAILED DESCRIPTION OF THE INVENTION below, it may be advantageous to set forth definitions of certain terms and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

In referring to the description, specific details are set forth herein in order to provide a thorough understanding of the examples disclosed. In certain instances, well-known methods, materials, procedures and components have not been described in detail for the sake of brevity of the present disclosure. However, it must be understood that a person of ordinary skill in the art is also a person of ordinary creativity, and thus a person of ordinary skill will be able to fit the teachings of this disclosure to various equivalents without departing from the spirit and scope of the invention. As used herein, the term “microenvironment” is used in the ecological sense to mean a very small ecological habitat (microhabitat) of mini or micro plants. In other words, the term microenvironment has the meaning of an ecological habitat limited to a small specific self-contained area which is distinguished from its immediate surroundings by the fact that the microhabitat includes live vegetation (organic live plants) and its immediate surroundings includes non-organic materials. The term “modular” is given its plain meaning relating to, or based on a module or unit as a basis for design or construction of flexible organized arrangements that can be replicated.

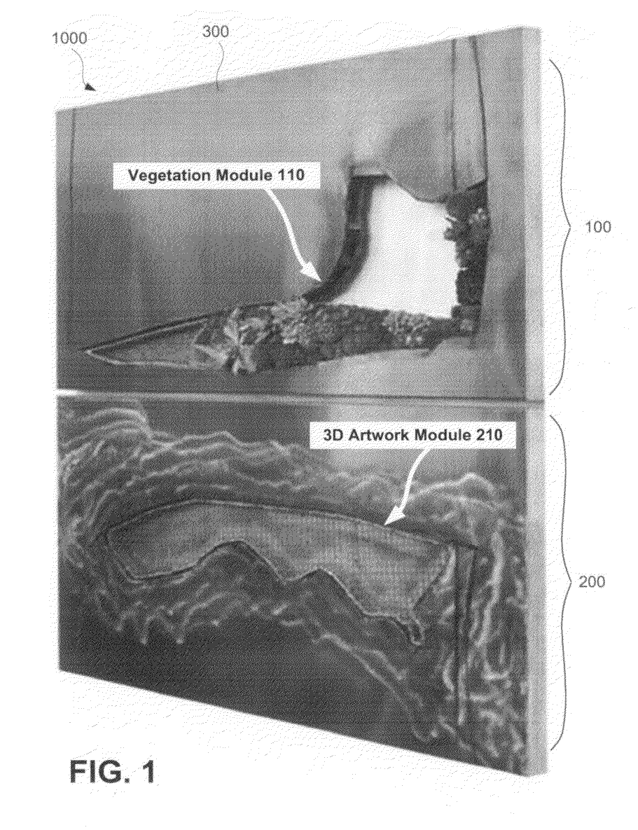

Referring now to the drawings where similar reference numerals refer to similar parts and functions, FIG. 1 is/illustrates a first embodiment of a Modular Microenvironment Tile (MMET) 1000. In the embodiment of FIG. 1, the MMET 1000 includes a base structure or base frame 300 (may also be referred to simply as a “frame”) containing a first section 100 which includes a vegetation module 110 and a second section 200 with contains an artwork module 210.

The base frame 300 is of generally flat structure having front (first) and back (second) surfaces and outer edges or sides to form an irregular complex shape, or a regular square, rectangular, triangular, or circular outer shape of any depth or volume. The base frame can take any polygonal, curved, or mixed shape. Although it would advantageous, in terms of facilitating mass production, if the outer shape of the base frame 300 was defined by a geometrical shape, the base frame 300 can have a non-geometrical (i.e., an irregular) outer shape. On the first surface (front surface), the base frame 300 includes one or more receptacles or spaces for receiving therein at least one vegetation module 110 and at least one artwork module 210. On the second surface (back or rear surface), the base frame 300 includes one or more perforations or other fastening means (not shown) provided in a known manner for its fastening to a surface or wall. It should be understood that fastening means, such as hooks, nails, screws, wires, anchors, magnets, and the like are well known and any such fastening means can be used. It should also be noted that fastening means may instead or in addition be provided on the outer edges of the base frame 300. Alternatively, the base frame 300 may be provided without fastening means.

The Modular Microenvironment Tile 1000 can be built from any kind of structurally appropriate material, such as metal, alloy, plastic or wood. It is preferable that the base frame 300 be made of sturdy and long-lasting material. Metallic materials, such as stainless steel, aluminum or copper are some examples of applicable materials. Synthetic materials, such as composites or plastics including Styrofoam™, Plexiglass™, Teflon™, and polyvinyl chloride (PVC), are examples of composite or plastic materials. The material for frame 300 should preferably enhance the maintenance of organic vegetation inside the tile. The materials used should not negatively affect the outlook of the tile, which is intended to be an article of manufacture containing ‘a section of living nature’ (vegetation elements) for providing a ‘symbiosis between nature, art and architecture’. To that end, the material or materials used should allow the highest possible visibility of the organic vegetation contents and should preferably blend with the surface or wall on which the title is attached. At the same time, the material of base frame 300 should allow for the easy incorporation of artwork either on the front surface of the frame itself or in a receptacle built within the body of the frame.

Other exemplary metals that can be used to construct the base frame include, without limitation, stainless steel, copper, gold, silver, aluminum, zinc, tin, lead, and combinations thereof. It naturally follows that metals and the other materials described herein can be combined as necessary. There are no limitations regarding the thickness of the materials to be used for the base frame 300, or regarding the shape, size or final appearance of the base frame, the vegetation module or the artwork module. Some consideration may be given based on the desired application, final look and use of the modular microenvironment tile. For example, if the MMET is intended to be mass produced and used as a building block for eco-friendly construction and design, at least the size, shape and materials should be chosen with such application in mind

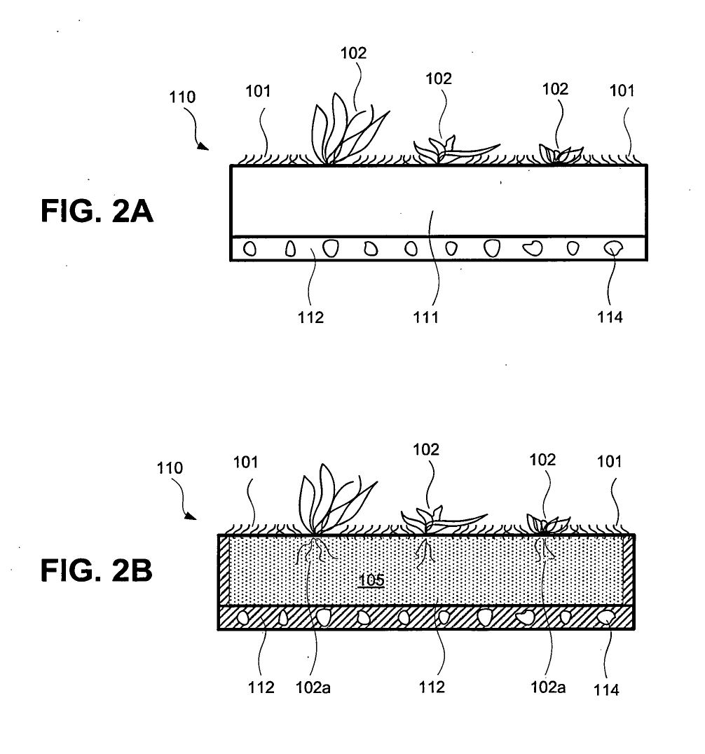

Turning now to FIGS. 2A, 2B, 3A, 3B, 4 and 5, a detailed description of the process for manufacturing an embodiment of the modular microenvironment tile (MMET) will be described as follows. First, as previously described, a suitable frame or base structure 300 (see FIG. 1) is chosen based on the desired need or purpose. Within the base structure 300, a first section 100 for containing a vegetation module 110 and a second section 200 for containing an artwork module 210 are provided. It is to be understood that more than one vegetation module 110 and more than one art module 210 may be included in each MMET tile. The dimensions (i.e., size, volume, footprint, etc.) of each of the first section 100 and the second section 200 are not particularly limited as long as each can contain the vegetation module 110 and artwork module 210, respectively. The vegetation module 110 of any shaped can be made from a variety of readily available materials, such as including (but not limited to) corrugated plastic (polypropylene) walls, hot glued to a corrugated plastic base. Making the base of this container watertight can be achieved with special epoxy resin glue, designed to bond polypropylene. An example of epoxy resin glue is Scotch-Weld™ commercially available from 3M®. Planting soil in a soil based vegetation module will be kept tightly in place by vinyl-coated wire grid through which plugs or seeds are planted, and plants can grow. Preserved moss—hot glued to the wire grid, can further be used to stop the soil from falling out, when the MMET is installed in vertical position. In addition, a felt based vegetation module can be made with standard felt-based vertical gardening technology and the addition of a watertight container or gutter on the bottom of the vegetation module.

FIG. 2A illustrates a side view of a soil based vegetation module 110, and FIG. 2B illustrates a cross-sectional view of the vegetation module 110. As illustrated in FIGS. 2A-2B, the vegetation module 110 includes a container 111 in which grass 101 and plants 102 (vegetation elements) are provided. At the base (lower part) of the container 111, a porous layer 112 is provided with openings 114. Inside the container 111, planting material 105 is provided. The planting material 105 is a substance that allows plants 102 and grass 101 (the vegetation elements) to grow roots 102a (i.e., the planting material allows vegetation elements to stay alive and grow). To that end, the planting material 105 preferably includes planting soil appropriate for the type of vegetation being used. More specifically, the type of soil should match the specific needs of the specific plants in use, and can vary from fast draining to damp. Planting material can also be synthetic felt, which is a well known material for vertical garden systems and requires no use of soil. As discussed supra, synthetic felt for planting can be obtained from Florafelt Vertical Garden Systems of Norcross Ga.

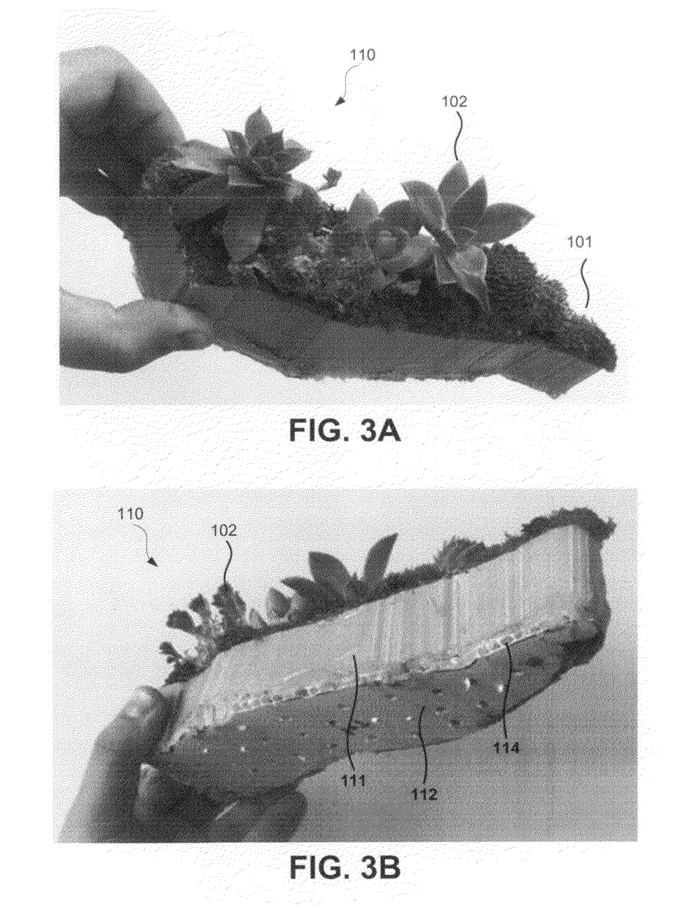

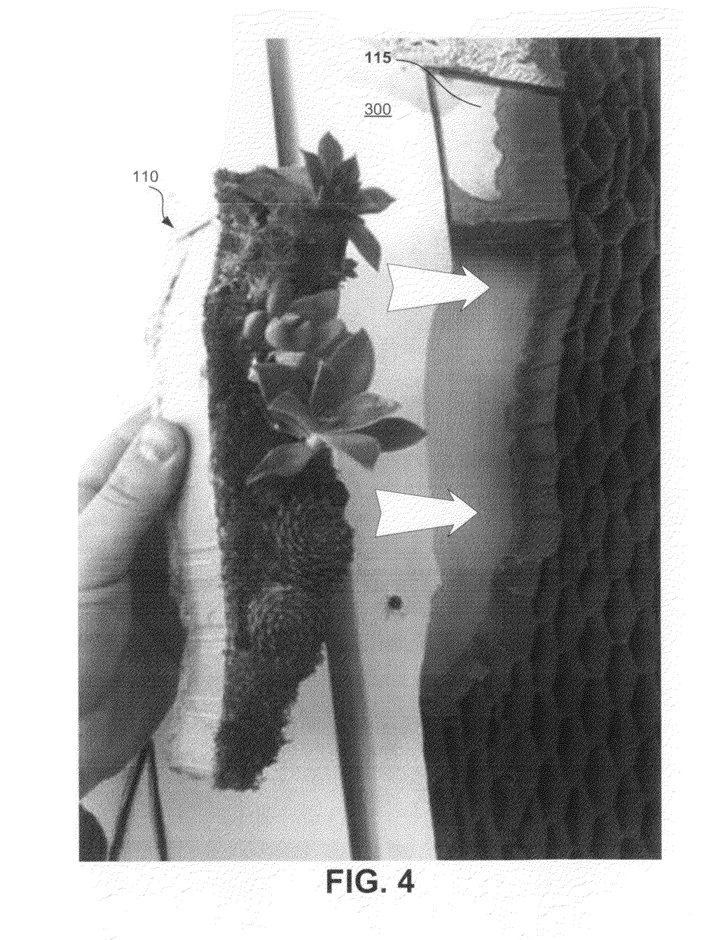

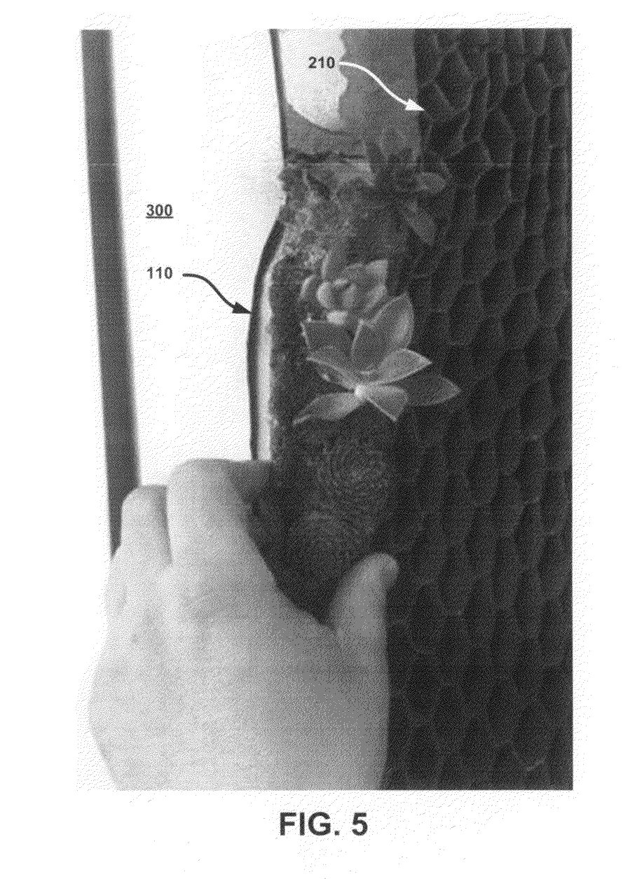

The vegetation elements (grass 101 and plants 102) planted in the planting material 105 of the vegetation module 110 should be preferably prepared before the vegetation module is attached to the base frame 300. More specifically, as shown in FIGS. 3A-3B, the vegetation module 110 should preferably include the vegetation elements (plants and grass) already arranged (living) in the planting material 105 prior to installing the vegetation module in the base frame 300. In this manner, the vegetation module 110 can be easily transferred onto the first section 100 of the base frame 300, as shown in FIG. 4. Finally, as shown in FIG. 5, the vegetation module 110 should be made in a manner that allows for easy installation and removal of it from the base structure 300. The artwork module 210 may be attached to the base frame 300 in a manner similar to the vegetation module 110 except that the artwork module does not include any vegetation.

As used herein “vegetation” refers to live plants or dead but seemingly live plants. More specifically, vegetation including live plants refers to mini or micro living plants including all their physical parts such as roots, stems, leaves and flowers (if any). That is, the term live plant refers to a biological alive plant (i.e., not dead). Preferably, these live or living plants would require minimum maintenance in terms of irrigation or growing space (i.e., the plants would not grow, or would grow at very slow rate). Examples of live plants (live vegetation) that can be used in the first section (in the vegetation module) of the MMET 1000 include, but is not limited to, live grass, moss, succulent mini and micro plants, small cactuses or ferns, or the like. Tropical plants, such as Riphsalis, are particularly well suited for indoor environments with low light situations when watering is frequent. All outdoor plants should be chosen to be hardy for the particular local weather and the specific sunlight and/or precipitation conditions.

Vegetation including “dead but seeming live plants” are plants that have been severed (cut-off) from their roots or natural environment, and thus do not require any maintenance in terms of irrigation or growing space. However these plants are preserved as seemingly live (i.e., these plants preserve their natural look). Artificial plants or flowers would not qualify as dead but seemingly vegetation because artificial plants or artificial flowers would defy the purpose of providing a symbiosis between nature, art and architecture.

Examples of dead but seemingly live plants (dead but seemingly live vegetation) that can be used in the first section (vegetation module) of the MMET 1000 may include dry grass or dry moss, dried flowers, dead but preserved plants (e.g., dried plants cured with chemicals to prevent rotting, molding or decay). In addition, along with dried and cured plants and flowers, dried and plasticized moss or grass can be arranged in the vegetation module to recreate a more realistic natural environment.

The “artwork” used in the second section 200 (artwork module 210) of the MMET 1000 may include (without limitation) a partial or complete painting, a piece of sculpture, an artistic poster, an advertising placard, grow light system, or even a smart electronic display (for example, an LCD: liquid crystal display). Currently grow lights are readily available in a variety of forms from many commercial suppliers. However, to add to the concept of artwork as used in this application, it is preferable to use LED grow lights at a wavelength that benefits growth of the plants in the vegetation module installed in the close proximity to the artwork module. Examples of grow light include, but are not limited to, EVO 360 Full Spectrum or EVO 280 flower extreme available from GROWBLU of Arlington Wash. In other words, the second section 200 of the MMET 1000 is a section that includes artwork of any type, except vegetation. It is preferably however that the artwork module includes three-dimensional artwork such as sculptures made of mixed media. Three-dimensional artwork can include sculptures made of deformed metal sheets or three-dimensional formations made of polymers, such as adhesives or acrylics used for visual effect or protective coating. Moreover, as noted above, three-dimensional artwork may include lighting in the form of decorative lights to enhance the color of plants or grow lights to promote grow or preserve the plants.

The artwork can be traditional painting on a panel with openings inside the painted panel, designed for embedding therein the vegetation module of the MMET. The artworks can contain a mixture of painting, mosaic, sculpture, grow lights, and new media such as LED lights and/or LCD screens while still functioning as a work of art. MMETs, in this case, will be embedded in designated openings or slots while functioning as a piece of the artwork design. MMETs can also include 3D sculpture/installation artwork that may contain the traditional and non-traditional elements such as paint, mosaic, objects, video screens, or projected images, and other electronic devices or media.

The MMET 1000 can contain non-vegetation decorative elements such as (but not limited to) rock, metal, or acrylic, which can be arranged to represent the artwork section 200 (i.e., the artwork module 210). In other words, the artwork module 110 is either part of the base frame 300 or is arranged in a permanent manner on the base frame 300 so as to be non-removable from the base frame 300. When the artwork module 210 is part of (or already included within) section 200 of the base frame 300, the base frame 300 needs to provide only a receptacle or space for receiving the vegetation module 110.

Therefore, the MMET can be ready-made with predetermined artwork and planted vegetation and can be provided ready to be installed (ready to be used). Alternatively, the MMET can also be offered with a layout plan containing descriptions of the layout of the specific plants, organisms and decorations, so the MMET can be replicated according to the preferences of the final user or consumer. To that end, the MMET can come as a DIY (do-it-yourself) kit including the base frame 300 with the vegetation module 110 and the artwork module 210 (basic structure) where the user decides on the contents of the vegetation and art for each module.

Three different types of MMET examples are described herein below. These are only some examples of how the MMET can be implemented. It is understood however, that persons having ordinary skill in the art will be able to vary these examples to make and use t present invention without undue experimentation.

A Type 1 MMET mainly consists of a base structure or base frame 300, a vegetation module 110 and an artwork module 210, as described above with reference to FIGS. 1 through 5. In the Type I MMET, the vegetation module preferably contains live and sustainable plants (and/or other living organisms) exposed to natural sunlight and/or grow light, and to urban environment and human touch. This configuration of MMET allows easy accessibility to the vegetation and permits a tangible way to interact with nature. More specifically, by having the plants, flowers, moss and/or grass exposed to the environment, the user can touch and actively interact with living organisms (plants) in the comfort of his/her habitat.

The Type 1 MMET can be used to build modular sustainable living natural additions to a variety of architectural elements, furniture, and ornamental objects. This basic Type 1 example may be implemented according to the description of FIGS. 1-5 described above to create a unique symbiosis between nature, art and architecture. The Type 1 MMET can be used to build modular indoor or outdoor gardens or modular vertical Live Walls of any pattern and shape. In the Type 1 MMET, the plants and the planting soil are contained in a specially designed MMET Planter System or vegetation module 110 as shown in FIGS. 2A, 2B, 3A and 3B.

The MMET Planter System or vegetation module 110 may be implemented in various manners. In a first example, the vegetation module 110 contains live or dead but seemingly live plants which require no irrigation. However, to provide ventilation to the planting soil, the openings 114 at the bottom and sides of layer 112 (see FIG. 3B) are exposed to air of the open environment. In a second example, the vegetation module 110 can be installed within or in contact with an enclosed water reservoir which can provide water to the plants through the openings 114. Alternatively, water for the plants can be manually delivered by removing the vegetation module 110 from the base frame 300 by manual irrigation. In this case, after irrigation, the vegetation module 110 would be returned to its enclosed compartment and the irrigation water would remain in the openings 114 of the porous layer 112. From the porous layer, water will be absorbed by plant's roots 102a by capillary effect.

In a third example, the bottom layer of the walls of the vegetation module 110 can be covered with the above-described synthetic felt. In this case, water can be supplied manually from the top of the vegetation module 110, by spraying or by pouring water into designated openings at the top of soil container or on top of a felt-based substrate. The water in this case would be gravity fed to the plants and the excess water would collect at the bottom of the container or a gutter base. A watertight container or gutter can collect any excess water. Since the felt wall extends into the watertight container or gutter, the water can then feed upwards to the plants, via capillary movement through the felt. With a porous or felt-based vegetation module, the vegetation remains static and allows for very easy watering.

In a fourth example, the vegetation module 110 can be connected to an irrigation system. In this case, irrigation water, and in some cases, even nutrients or pesticides, can circulate through the openings 114 either by a drip system or by powered irrigation system (as further described below).

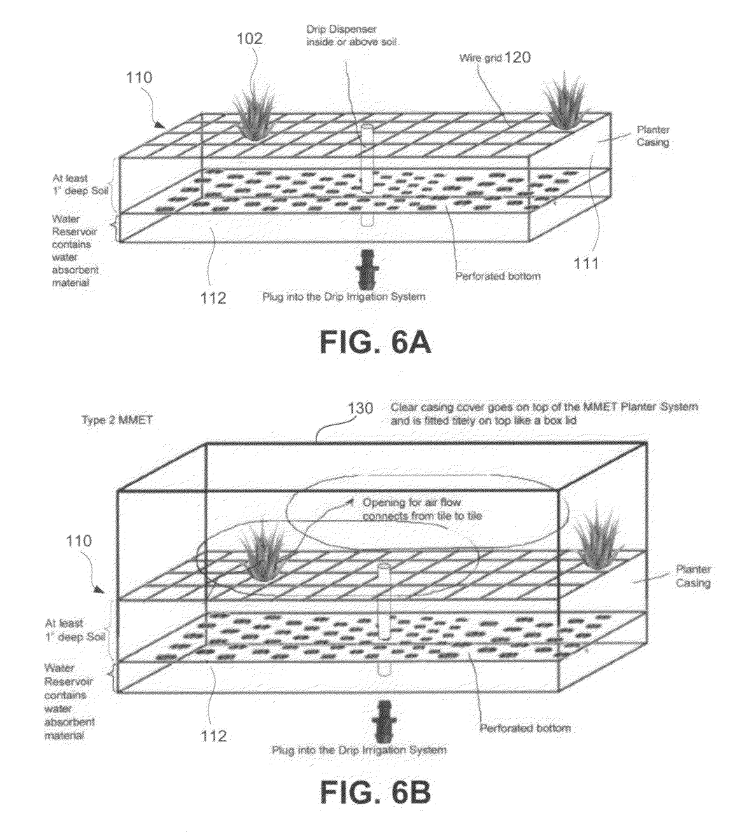

FIG. 6A illustrates an example of a Type 1 MMET in which the MMET 1000 includes a vegetation module 110 which can be connected to a drip irrigation system. In the example of FIG. 6A, the plants are maintained in the planting soil within the planter casing (container 111), while water is delivered via a drip dispenser arranged inside or above the soil. The water is then contained in the bottom or base layer 112. In this example, the plants are contained within the vegetation module with a wire grid 120 of that the plants do not move even if the MMET is installed vertically.

A Type 2 MMET is similar to the Type 1 MMET in that the vegetation module 110 is configured to plug into an irrigation system. In the Type 2 MMET, to avoid dripping of irrigation water and to protect the vegetation, the vegetation module 110 includes a protective clear casing 130. The protective clear casing 130 has openings that allow natural or powered airflow to circulate through the vegetation (plants) contained thereinside. When two or more MMETs are disposed together, the protective clear casing allows airflow from one MMET to another. The Type 2 MMET allows for almost complete isolation of the plants (and other living organisms) from the outside environment while maintain maximum visibility. The Type 2 MMET allows plants to be easily visible yet protected from environmental and physical impact. The visible front surface of Type 2 MMET can, for example, be used as a tabletop, a bench surface, and even embedded in a floor. In this manner, the MMET structure can be used not only for ornamental purposes, but also for aesthetic design purposes.

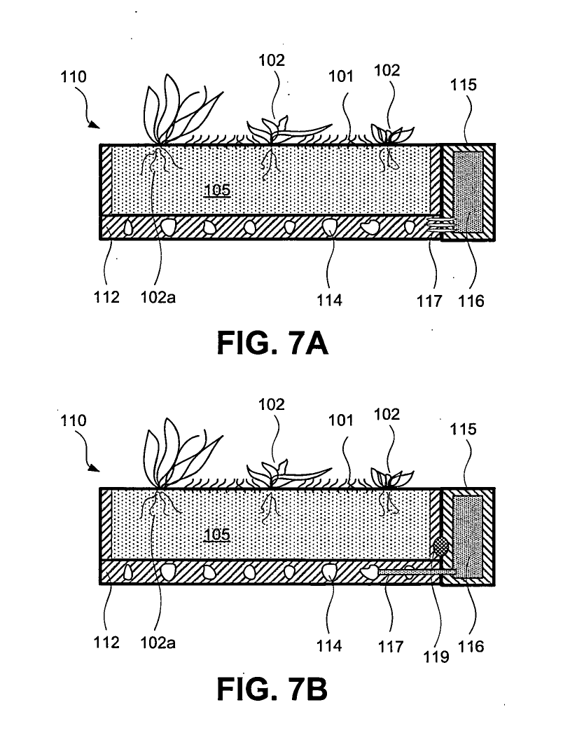

The irrigation system for the vegetation module 110 can be simplified so that no additional elements are required delivery of irrigation liquid. FIG. 7A illustrates an example in which an irrigation container 115 is attached to, or arranged in contact with, the vegetation module 110. In the example shown in FIG. 7A, the irrigation container 115 is provided with irrigation liquid 116 (water) and mini channels 117 connecting to the base layer 112. This is manner, the irrigation liquid 116 can be delivered, e.g., by gravity or pressure, from the irrigation container 115 to the vegetation module 110. FIG. 7B shows an addition example in which the irrigation container delivers irrigation liquid 116 to the vegetation module in a manner similar to that of FIG. 7A, but to avoid leakage of liquid outside of the vegetation module 110, a sealing gasket 119 (e.g. an “O” ring) is provided around the container 111.

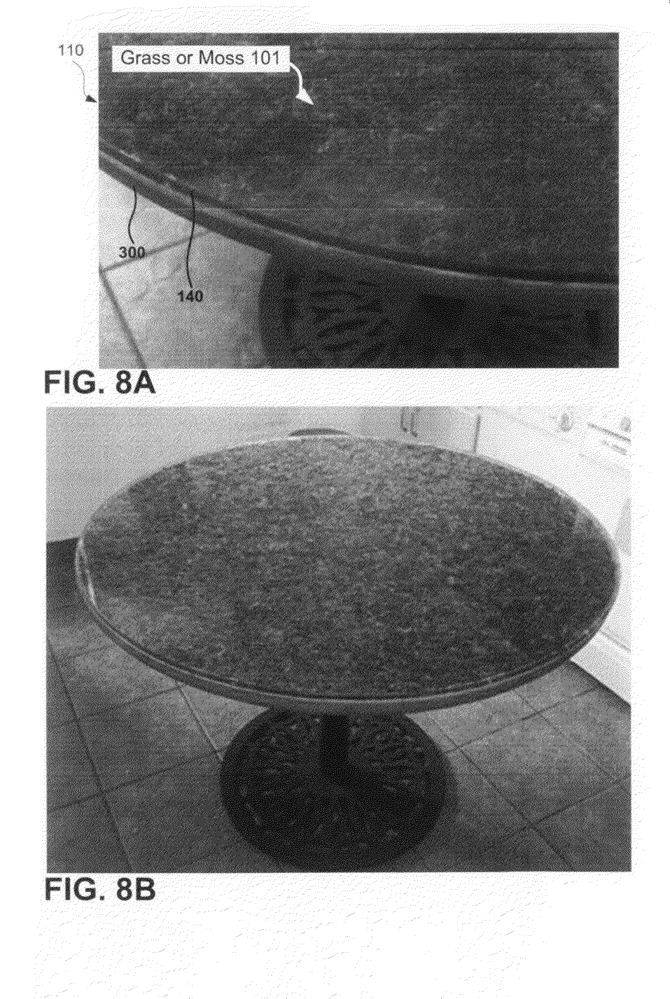

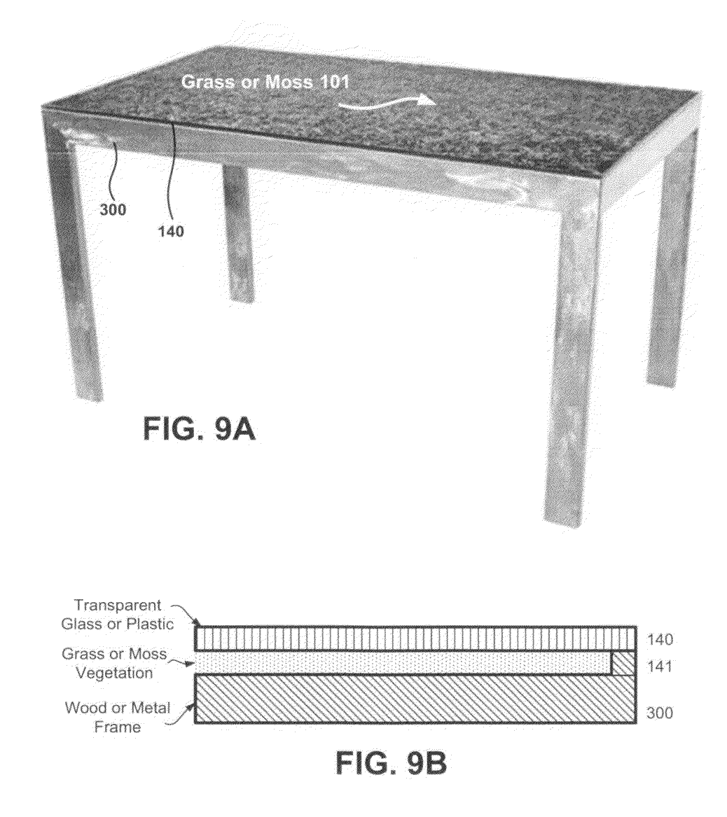

A Type 3 MMET is similar to the Type I MMET, but contains mainly dead but seemingly alive plants, which are cured, arranged and sealed inside a transparent cover made of see-through material such as glass or acrylic. FIG. 8A illustrates an example of a Type 3 MMET 100 having a vegetation module 110 with dead vegetation. The Type 3 MMET of FIG. 8A does not contain any live organic elements which would require space for organic growth. Therefore, in the Type 3 MMET, the vegetation module 110 does not need space for soil or irrigation. FIG. 8B shows a cross-sectional view of the vegetation module 110. FIG. 8B shows a complete three-dimensional view of a vegetation module forming a surface of a table; As shown in FIG. 9B, grass or moss 101 is sandwiched between a transparent cover 140 and the base frame 300. A spacer 141 is used to prevent the moss 101 from being pressed and damaged. The cover 140 is made of glass or plastic to provide maximum visibility for the user to see the vegetation; and the base frame 300 is made of wood or metal to support any weight or pressure placed upon the upper surface thereof. However, the vegetation in the Type 3 MMET looks alive and as if it contained live plants. In the examples of FIGS. 8A and 8B, green moss 101 is enclosed on a bare surface (base frame 300) and is sealed with a transparent (see-through) cover 140. Be it installed on a wall or on a floor, as addition to architectural elements, or on a tabletop or a seating surface, as a decorative aspect of furniture, the vegetation module 110 of the Type 3 MMET can be used inside or outside. In this manner, the Type 3 MMET allows for high visibility yet complete protection and isolation of the organic vegetation elements. It requires no maintenance, other than occasional cleaning of the protective surface to maintain optimal visibility.

Examples of various practical applications of the MMET 1000.

The Modular Microenvironment Tile (MMET) 1000 may be offered as a modular building block or designing block of any shape, dimensions and volume, as long as it mainly consists of a first section having vegetation and a second section having artwork. The light can come from natural sunlight. Alternative to natural sunlight is the readily available grow light, designed to promote plant growth, even in environments lacking natural sunlight. The grow light source can be installed as part of the MMET, or outside of the MMET (part of the interior design) with significant amount of light spotlighting the vegetation The vegetation contains live and sustainable, visible plants (and/or other living organisms) and/or dead but seemingly alive plants (and/or other dead but seemingly alive organisms). The living plants and/or organisms are chosen for their hardiness to specific temperatures and watering patterns, specific low maintenance requirements, specific lighting needs that are being met by natural sun light, grow light source installed as part of the MMET, grow light source installed as spotlights and/or diffused light in the close proximity to the installation of the MMET, and the desired growth size and life span. As noted above, in certain environments it may be preferable vegetation with minimum growth size and maximum life span. The MMET can contain technological parts that sustain and/or enhance the natural or ‘natural meets architectural’ look of the tile, such as (but not limited to) irrigation systems or LED lighting systems. Very much like the old fashioned tile or the above-referenced modular planters, the MMET can be installed as a single piece of ornament, or in it can be installed in arrays of multiple tiles as part of a surface structure, such as a wall, floor or rooftop. Therefore, MMET can be installed indoors or outdoors.

When installed in multiple tiles, the MMET can be installed to form a geometrical two-dimensional grid (lattice) or an irregular pattern. The MMET can be attached or embedded into an existing surface of a wall/floor/ceiling/rood/etc., or it can be used in multiples to cover an entire section of space. The MMET can be installed vertically or horizontally, as a floor, as part of furniture, or as a tabletop surface. That is, it can be embedded in architectural elements or embedded into furniture to create unique symbioses between nature, art and architecture. In the case of an MMET having the vegetation module with live vegetation (plants and organisms), the presence of sunlight and/or grow light will be necessary, maintenance and/or occasional replanting or replacement may be required.

FIG. 9 illustrates an example in which vegetation module 110 and the artwork module 210 are arranged as part of a table surface. In this case, the table surface itself becomes the base frame 300, and a transparent cover 140 is used to cover and protect the vegetation (moss) covering the base frame.

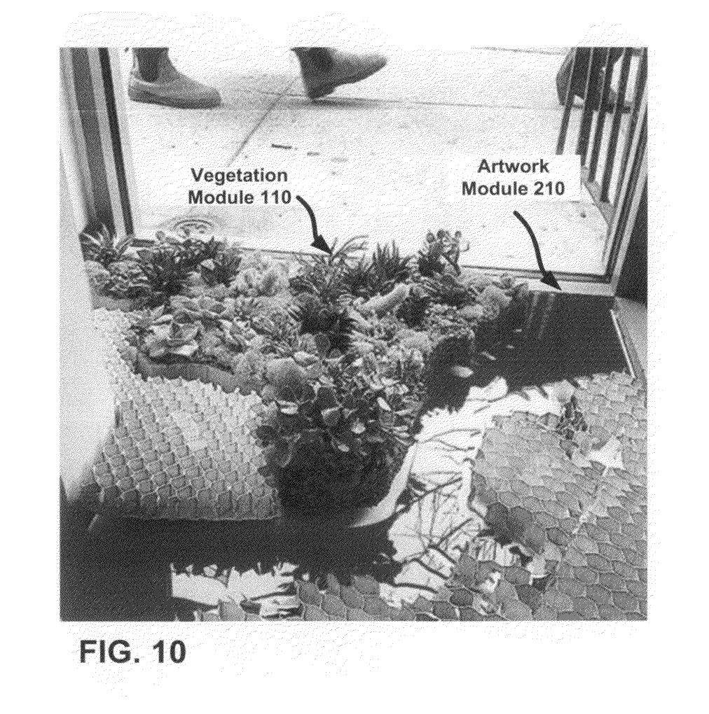

FIG. 10 illustrates an example in which the MMET 1000 has a generally rectangular flat shape with plural (2) vegetation modules 110 and the remainder of the base frame 300 has been used as the artwork module 210. In this case, the MMET 1000 can be used as a design or ornamental building block for environmental friendly habitats or workspaces.

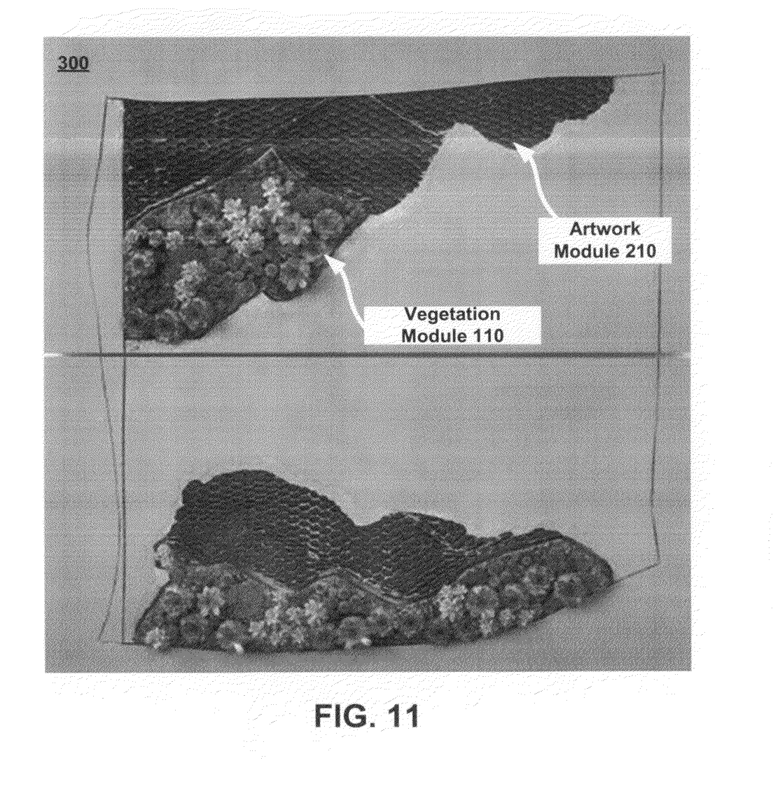

FIG. 11 illustrates an example in which the MMET 1000 has an irregular shape, and it includes several vegetation modules 110 and several artwork modules 210. The base frame 300 has irregular shapes and is embedded on a wall. In this case too, the MMET 1000 can be used as a design or ornamental building block for environmental friendly habitats or workspaces. As shown in FIG. 11, the MMET 1000 can be used as a design or ornamental building block for environmental-friendly habitats or workspaces.

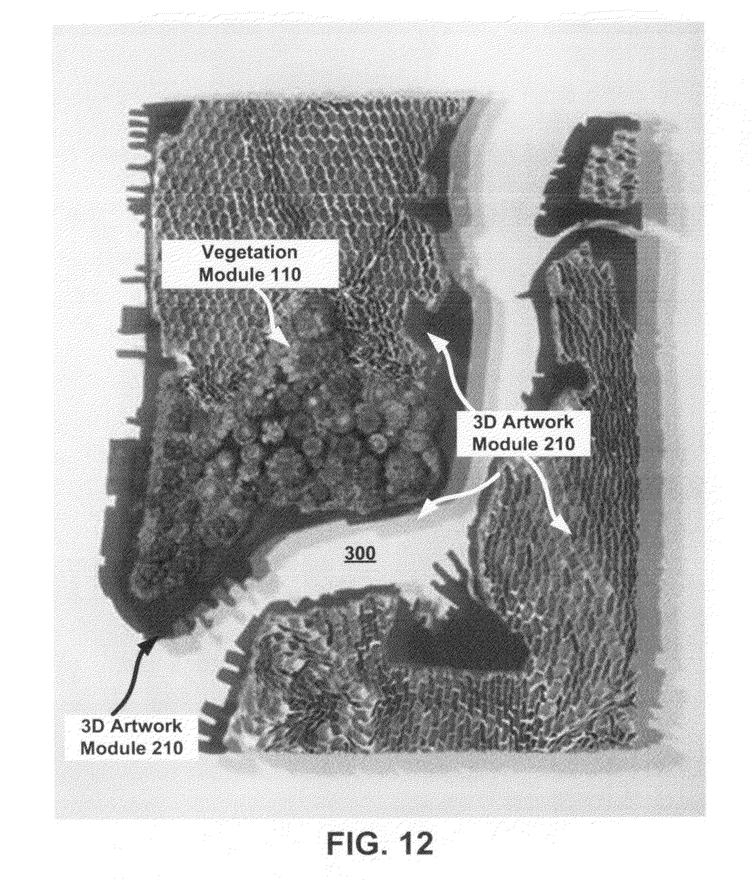

FIG. 12 illustrates an example in which the MMET 1000 has plural (2) artwork modules 210 and a single vegetation module 110. These modules are separately attached to a wall. As shown in FIG. 12, the vegetation module is completely surrounded by the three-dimensional art.

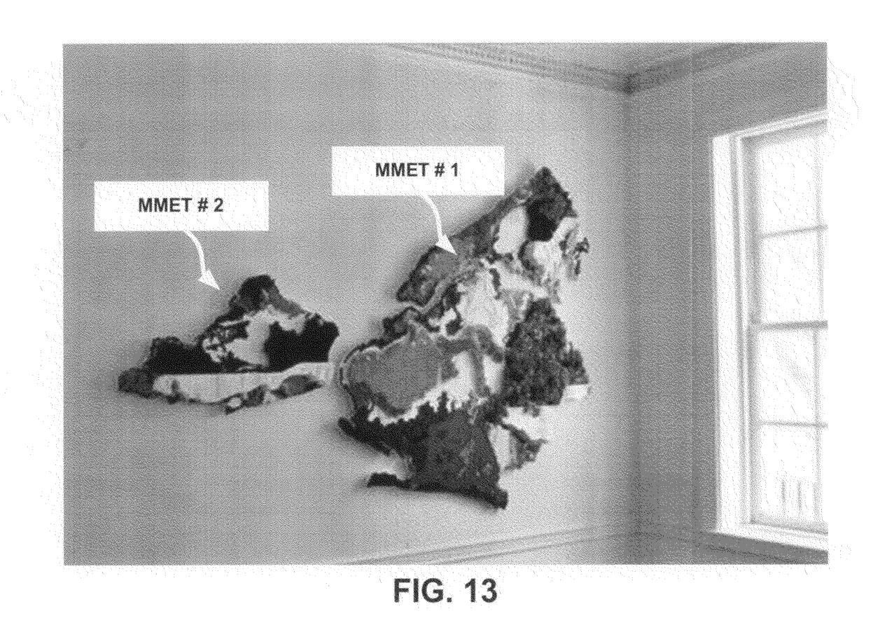

FIG. 13 shows a working example in which a plurality of MMET units each having a vegetation module and an artwork module are arranged on a wall surface according to the present invention. An exemplary use of the MMET in mixed media with three-dimensional artwork and a vegetation module, created by the present inventor Ivan Stojakovic, comprises one or more vegetation modules of mini or micro plants designed to resemble forested areas within landmasses represented by the shape and look of the artwork. For example, as shown in FIGS. 12 and 13, plural MMETs are used to represent a map of New York City Boroughs, and within each MMET, artwork modules containing mixed media sculptures represent the footprint of a landmass of map, and vegetation modules with live plants represent a possible spread of vegetation or green areas on the map.

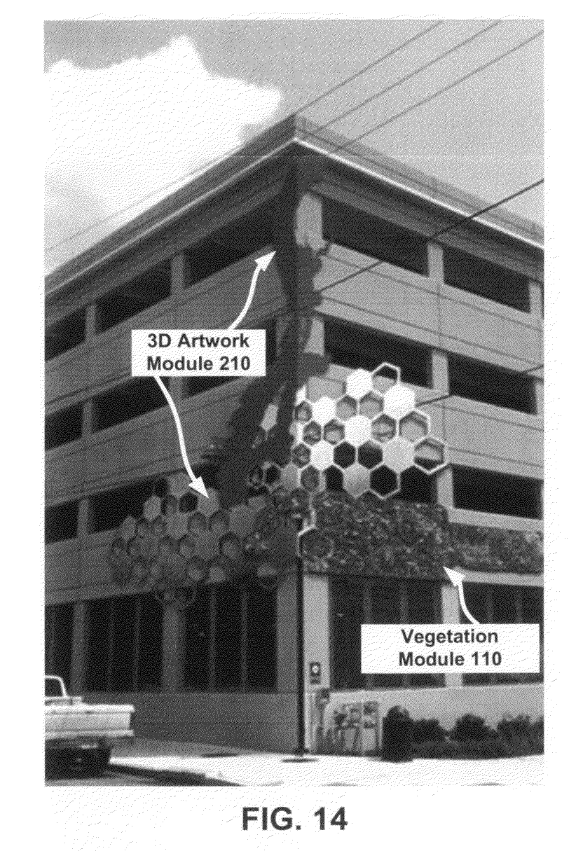

Although, some aspects of the present invention are directed to, and have been described as, a modular microenvironment tile (MMET), the present invention is not limited to a micro (small) tile per se. This type of functional structures can be tailored to meet various needs whether they are ecological, architectural, ornamental, commercial, etc, at any scale. For example, FIG. 14 illustrates a further application of an irregularly shaped MMET 1000 including a three-dimensional artwork module 210 and a vegetation module 110 in a large scale to cover entire walls for a building several stories tall.

Those skilled in the art will appreciate that many variations are possible within the scope of the examples described herein. Thus, while the features of the invention have been described with reference to particular embodiments, it will be understood that structural and functional modifications may be made without departing from the scope of the following claims.

What is claimed is:

1. A modular microenvironment tile comprising:
a first section configured to retain vegetation module;
a second section configured to retain an artwork module;
wherein the vegetation module includes at least one of live vegetation and dead vegetation and the artwork module includes three-dimensional artwork non-including vegetation.

2. The modular microenvironment tile according to claim 1, further comprising a base frame,
wherein the vegetation module is removably contained within a receptacle formed in the base frame,
wherein the artwork module is formed on a surface of the frame, and
wherein the artwork module includes a three-dimensional work of art made of mixed media that may include grow lights.

3. The modular microenvironment tile according to claim 1, wherein the live vegetation includes one or more of live plants with or without flowers, live grass, live moss, live ferns or live cactus,
wherein the vegetation module comprises a water proof base with two or more layers of synthetic felt on top, providing openings in a top layer of felt in which plants are rooted,
wherein the water proof base with the two or more layers of felt is configured to allow delivery of air, water, or plant nutrients to planting soil contained between two or more layers of synthetic felt.

4. The modular microenvironment tile according to claim 1, wherein the live vegetation includes one or more of live plants with or without flowers, live grass, live moss, live ferns or live cactus,
wherein the vegetation module comprises a hallow container having a porous base, the container configured to contain planting soil to receive the live vegetation, and wherein the porous base is configured to allow delivery of air, water or plant-nutrients into the planting soil.

5. The modular microenvironment tile according to claim 1, wherein the vegetation module includes live plants and is configured to be connected to an irrigation system for supplying water and/or nutrients to the plants.

6. The modular microenvironment tile according to claim 1, wherein the base frame has a geometrical outer shape defining a polygon or a circle containing within said outer shape the vegetation module and the artwork module.

7. A method of making microenvironment tile, comprising:
forming a base frame having a front surface, a back surface and outer edges joining the front and back surfaces, and
attaching a vegetation module and an artwork module to the base frame,
wherein the an artwork module is configured to be mounted in a permanent manner on the base frame, and the vegetation module is configured to be mounted in a removable manner on the base frame, and
wherein the vegetation module is configured to contain live and/or dead vegetation and the artwork module is configured to contain three-dimensional artwork except vegetation.

8. An apparatus for covering a surface or wall with vegetation and art, comprising:
a base frame configured to be attached to the surface or wall;
an artwork module configured to be mounted in a permanent manner on the base frame; and
a vegetation module configured to be mounted in a removable manner on the base frame,
wherein the vegetation module is configured to contain live and/or dead vegetation and the artwork module is configured to contain three-dimensional artwork and in some cases grow-lights but not vegetation.

9. The apparatus according to claim 7, wherein the vegetation module comprises a hallow container having a hermetic wall with a porous base at one end thereof and an opening opposite to the porous base at the other end thereof,
wherein the container is configured to hold organic planting material or non-organic material for receiving the vegetation.

10. The apparatus according to claim 7, wherein the vegetation module comprises a water resistant base to which two or more layers of synthetic felt are attached, and
where in the top layer of felt has openings in which plants are rooted

11. The apparatus according to claim 7, wherein the vegetation module includes live plants and is configured to be connected to an irrigation system for delivering water or nutrients to the plants.

12. The apparatus according to claim 7, wherein the three-dimensional artwork includes a sculpture built on a visible surface of the base frame,
wherein the vegetation module includes a plurality of live plants and dead but seemingly alive grass or moss, and
wherein the vegetation module is completely surrounded by the three-dimensional artwork.

13. The apparatus according to claim 7, wherein the three-dimensional artwork includes a grow light installed in close proximity to the vegetation module.
